(19) United States
(12) Patent Application Publication
(10) Pub. No.: US 2025/0353358 A1
(43) Pub. Date: Nov. 20, 2025

(54) DIRECT AIR CAPTURE SYSTEM

(71) Applicant: Planetwest LLC, Sacramento, CA (US)

(72) Inventor: Chris Catlin, Sacramento, CA (US)

(21) Appl. No.: 19/207,381

(22) Filed: May 14, 2025

Related U.S. Application Data
(60) Provisional application No. 63/647,819, filed on May 15, 2024.

(51) Int. Cl. B60H 3/06

(52) U.S. Cl. CPC B60H 3/0633; B60H 3/0658; B60H 2003/0683

(57) ABSTRACT

A direct air capture system for capturing, containing, and transporting airborne matter includes a filter assembly, a particle container configured to receive airborne matter loosened from the filter assembly, a means for cowling venting configured to utilize vacuum pressure to transport the airborne matter. The system also includes an electric motor assembly having a motor drive, a drive gear, and a drive shaft, as well as at least one scrubbing brush configured to loosen airborne matter from the filter assembly.

### RELATED U.S. APPLICATION DATA

This application claims priority to Provisional Patent Application No. 63/647,819 filed on May 15, 2024.

### FIELD OF THE INVENTION

This disclosure relates to the field of environmentally beneficial air filtration systems, particularly with regard to direct air carbon capture (DAC) devices.

### BACKGROUND

Throughout earth's history maintaining stable surface temperatures has been essential for sustaining life. Central to this delicate balance is the natural regulation of atmospheric carbon dioxide levels. But that regulation system has broken down. Energy consumption is increasing with every new technology revolution, including the Internet, AI, robotics, satellites, etc. Global carbon emissions rose almost 1% last year amounting to a total 35 billion metric tons per year, the highest level on record. 18% of all global carbon emissions come from the 100 largest cities, including 250 MT/yr in Seoul, 200 MT/yr in Guangzhou/200 MT/yr in New York, Los Angeles, and Hong Kong, 150 MT/yr in Singapore, Chicago and Shanghai. The future requires even more energy. There is an exploding number of data centers for AI, bitcoin, IoT, electric vehicles, robots, automated manufacturing, and animation. While we wait to do something, global warming could cost the world up to $24 trillion over the next 36 years, according to scientists at University College London.

Since the start of the industrial revolution, human activity has released almost one trillion billion metric tons of carbon into the air. Accumulation of CO₂ and other GHG in the atmosphere has placed life on our planet under siege. However, man has not been able to solve this problem after many years of effort and billions of dollars of investment. Over the past 30 years, man's solution, generally called decarbonization, operates in two forms. Defensive types of technology like solar and wind replace IC engine emissions while offensive types like direct air capture (DAC) catch carbon in the air and move it underground. So far, decarbonization does not work well enough to slow global warming. For example, Volvo has recently admitted electric versions of its gas-powered cars are only 5% cleaner. EV efficiency depends on the type of fuel being used in the electric grid. New studies based on EROI (energy return on investment) reveal how badly solar and wind actually perform on a EROI basis. EROI is energy produced by a device less the energy consumed during its entire lifecycle, as it progresses through manufacturing, service, operation, and recycling. It is the true energy output of a device. EROI of various energies (according to Scientific American) are as follows: Hydropower 40+, Wind 20, and Solar 0.03. It means, for instance, that hydro produces approximately 40 times more energy than it consumes, and solar barely produces energy as compared to oil (10), NG (5), coal (9), and nuclear (3).

Current carbon capture systems are overly dependent upon a small number of large expensive units designed to absorb large amounts of CO₂ over short distances. These platforms are further dependent upon a host of enabling capabilities, such as connection to renewable power, water sources, advanced manufacturing systems, etc. Carbon capture efficiency based on carbon captured less carbon created by energy consumed in the process has been estimated to be 10-15%. Such DAC technologies capture carbon at a high cost. The company, Heirloom, reports $7,000 to $100,000 per metric ton cost of their newest DAC operating plant. Also, such DAC technologies are primarily analog-controlled, without the benefit of newer computing breakthroughs. As well, it requires a logistics “tail” of support personnel who are well-paid and must be well-trained in all elements of DAC technology. Conventional systems include many parts requiring an extensive and vulnerable supply chain. They cannot protect against the growing number of serious toxic pollution accidents. Moreover, they cannot guarantee safe, permanent sequestration of CO₂ for thousands of years. Such technologies only capture CO₂, but there are a number of other particles in the air that not only heat the atmosphere but also have major effects on human health, these particles including pollution, plastic microparticles, PFAS microparticles, radioactive particles, and tire wear particles. Current systems target CO₂ gas to capture carbon. CO₂ gas has a constant density worldwide of about 400 PPM-about 0.04% of the total atmosphere.

It takes an enormous amount of money to capture and separate carbon from CO₂ requiring a slow build, complex DAC plant. To stop global warming, it has been estimated by several major sources to cost up to $200 trillion dollars over a ten-year period to scale DAC technology worldwide. Conventional DAC systems need more infrastructure spending for power, water, and space. They must focus on optimal locations that have low land values, nearby sources to inject captured carbon, and very low cost and available renewable energy sources. Many such systems are in the form of large-scale fixed site plants, though the target of their effort to reduce carbon is CO₂ which is always moving and spread out. These systems further require high temperatures. The two main direct air capture systems in use today have different temperature requirements, which impacts the types of energy required to operate them. Liquid solvent systems require 900 degrees C. to release captured CO₂ whereas solid sorbent systems require 80 degrees to 120 degrees C. For both systems the energy is roughly 80% heat and 20% electricity. Miniaturized CO₂ technology as car-based capture systems are cumbersome and require the entire car to be redesigned around the DAC system.

Thus, there is a need in the art for a more intelligent, energy-efficient, and sustainable direct air capture system.

### SUMMARY

The present disclosure relates to a direct air capture system designed for integration with a vehicle, wherein the system is capable of capturing, containing, and transporting airborne matter such as carbon dioxide (CO₂), particulate matter (including radioactive and chemical substances), and pathogens during vehicle operation.

The system includes a radiator assembly with a cooling fan, and an air filtration device mounted between the radiator assembly and the vehicle's front grill. The air filtration device comprises a multi-stage filter assembly having primary, secondary, and tertiary particle filters each constructed as cartridges with lengthwise grooves. The primary filter utilizes a woven metal mesh to capture road debris; the secondary filter is composed of a PM10-rated membrane material; and the tertiary filter features a PM2.5-rated membrane with lengthwise tracks to accommodate a vacuum system. A particle container positioned between the secondary and tertiary filters collects airborne matter loosened from the filters. The filter assembly and particle container are housed in a structure that receives the cartridge grooves. Cowling piping is integrated to pressurize and vent airflow while increasing surface area for particle capture. A vacuum mounted via the tertiary filter's tracks pulls airborne contaminants into the particle container.

In some embodiments, a fluorocarbon polymer coating is applied to the housing, cowling piping, and particle container to improve the flow of captured particles. The cowling piping may also include air ducts designed to reduce air pressure during high-speed airflow.

Additional enhancements to the air filtration device include a sliding tube structure comprising a manifold of vertical air tubes connected to a lower horizontal air tube. This structure is configured to move laterally so that each vertical tube passes over a 5-inch section of the filter assembly. Each vertical air tube includes a slit oriented toward the filter surface and is connected to an internal vacuum to extract airborne matter through the slit. The vertical tubes may also include scrubbing brushes that assist in dislodging particulate material from the filters.

To further improve particle removal, the system may also incorporate a grid of high-pressure air jets directed at the particle filters, as well as a mechanism for emitting low-frequency sound blasts to loosen adhered contaminants.

In some embodiments, a sensor mast is located between the secondary and tertiary filters, and is configured to detect air velocity, temperature, and pollution metrics of the airborne matter being filtered.

This multi-layered system is designed to operate efficiently during vehicle motion and enhance environmental air quality through active airborne pollutant capture.

### BRIEF DESCRIPTION OF THE DRAWINGS

FIG. 1 illustrates a side view of a portable DAC device in accordance with an embodiment of the present disclosure.

FIG. 2 illustrates a front perspective view of a portable DAC device in accordance with an embodiment of the present disclosure.

FIG. 3a illustrates a side view of a vehicular direct air capture system utilizing a portable DAC device in accordance with an embodiment of the present disclosure.

FIG. 3b illustrates a side view of another vehicular direct air capture system utilizing a portable DAC device in accordance with an embodiment of the present disclosure.

FIG. 4a illustrates a contextual view of a direct air capture system used in a power plant in accordance with an embodiment of the present disclosure.

FIG. 4b illustrates an upper perspective view of a direct air capture system intended for use in a power plant in accordance with an embodiment of the present disclosure.

FIG. 4c illustrates a partially contextual exploded perspective view of a direct air capture system used in a power plant in accordance with an embodiment of the present disclosure.

FIG. 5a illustrates a side view of a rotating filter for a direct air capture system in accordance with an embodiment of the present disclosure.

FIG. 5b illustrates a front view of a rotating filter for a direct air capture system in accordance with an embodiment of the present disclosure.

### DETAILED DESCRIPTION

In the following discussion, numerous specific details are set forth to provide a thorough understanding of the disclosed subject matter. However, those skilled in the art will appreciate that the present disclosed subject matter may be practiced without such specific details. In other instances, well-known elements, processes or techniques have been briefly mentioned and not elaborated on in order not to obscure the disclosed subject matter in unnecessary detail and description. Moreover, specific details and the like may have been omitted inasmuch as such details are not deemed necessary to obtain a complete understanding of the disclosed subject matter, and are considered to be within the understanding of persons having ordinary skill in the relevant art.

The present invention provides a system with a plurality of highly adaptable direct air capture (DAC) carbon filtration devices, allowing for several embodiments of the device. A first embodiment provides a portable filtration device for cars and trucks, the device having non-moving parts for filtration. A second embodiment provides a horizontal filtration device for power plant smokestacks. A third embodiment provides a rotating filtration device for smaller scale applications.

Embodiments of the present invention include a device capable of interacting with airborne matter or particles, the device comprising a primary particle filter, a secondary particle filter, a tertiary particle filter, a cowling, a drive shaft, vacuum arms having brushes, suctioning means, air injectors, washers, an electric motor drive and drive shaft, a particle container, a support structure, a first strut, a second strut, a third strut, debris ducts, and suction wings.

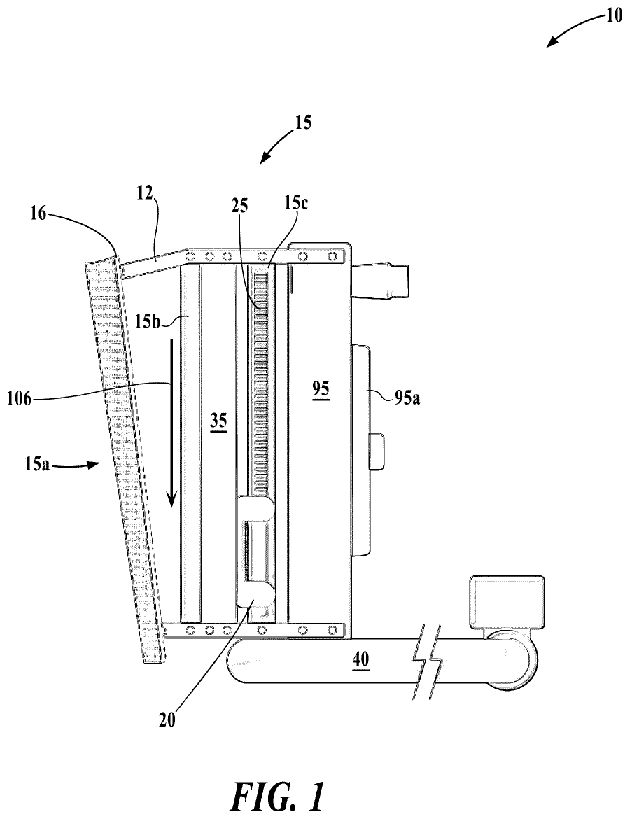

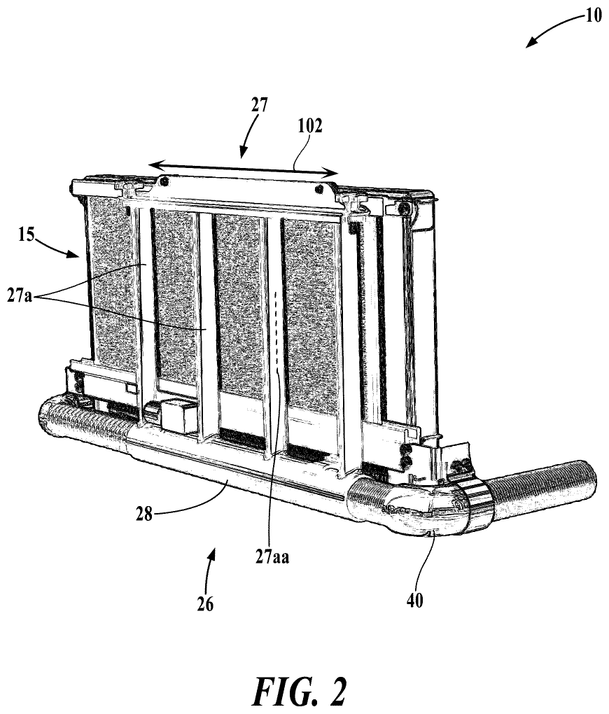

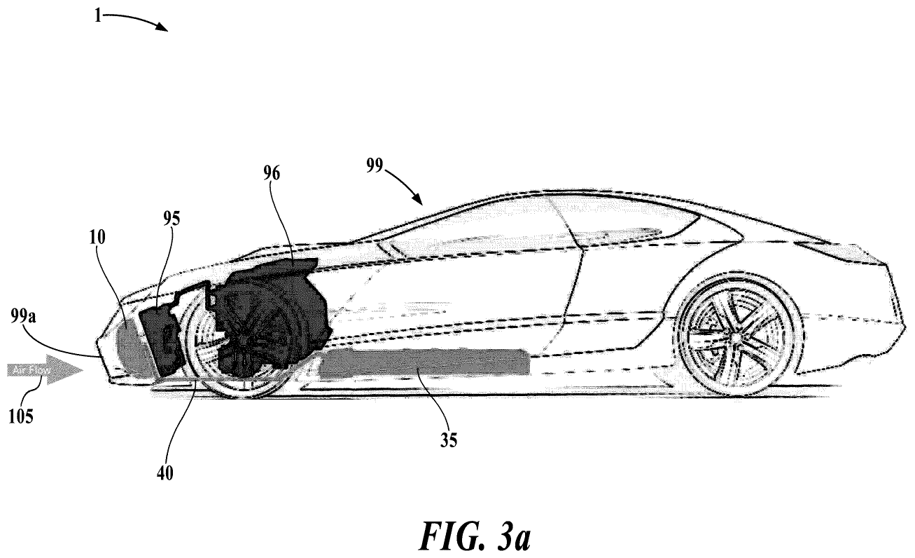

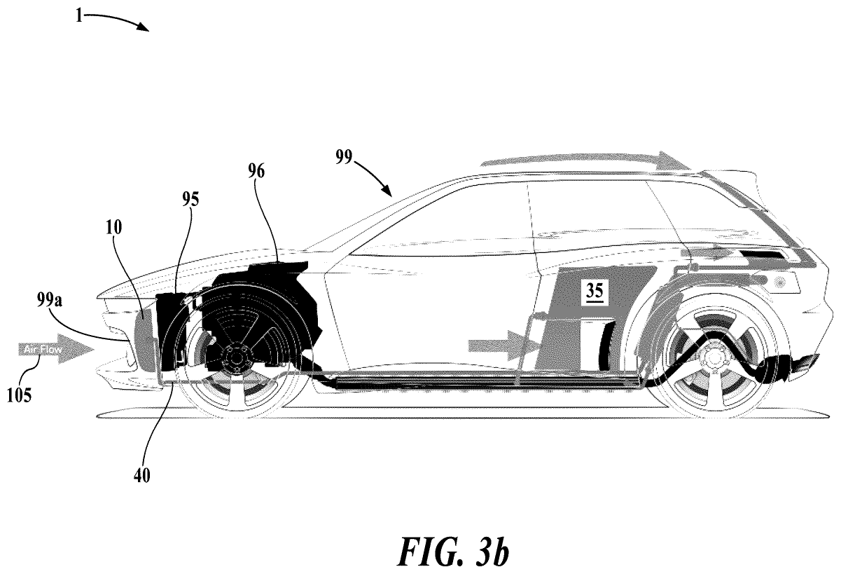

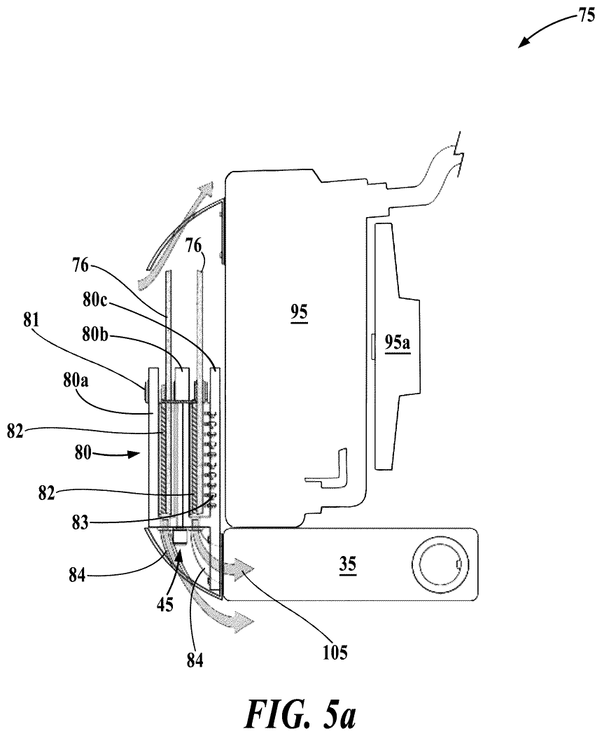

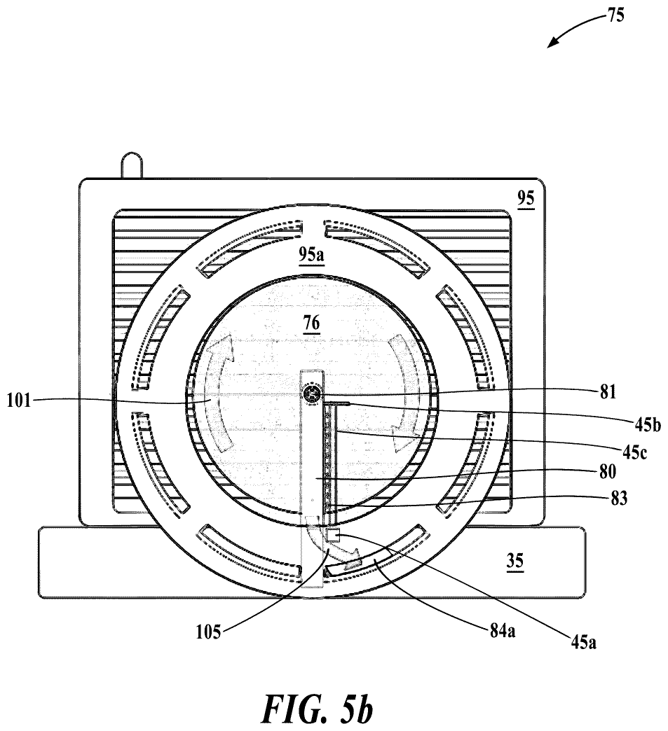

Referring to FIG. 1, FIG. 2, and FIG. 3 (3a and 3b), an exemplary embodiment of the present mechanical and electrical DAC system 1 is in the form of a portable carbon capture device 10, the DAC device 10 having approximately the same height and length as a vehicle's radiator assembly 95 (see FIG. 2 for approximate lengths of these components), the radiator assembly 95 having a front end and a back end and comprising a cooling fan 95a. The portable carbon capture device 10 is installable within a vehicle 99 proximate to the radiator 95 and engine block, or internal combustion engine (ICE), and composed of various materials including plastic and metals. The DAC device 10 comprises a housing 12, a side-mounted vacuum component 25, a filter assembly 15, and cowling piping 40 for venting captured air. The filter assembly 15 includes a primary particle filter 15a, secondary particle filter 15b, and tertiary particle filter 15c. A fluorocarbon polymer coating, such as polytetrafluoroethylene, is added to internal walls of the housing 12, cowling piping 40 and particle container 35 to improve particle flow. The portable DAC device 10 is attached directly to the front of the vehicle's radiator assembly 95 (references to front and back here being relative to the vehicle's front end and back end, respectively). A metal or plastic cowling 40 is attached to the back of the DAC device 10. It is designed to direct most of the incoming air into the DAC device 10, the incoming air entering the front of the vehicle 99 while it is in motion. The cowling 40 promotes increased pressure for the airflow, along with increasing the overall surface area of particle capture. Air ducts (see debris duct 84 of FIG. 5b for an example of a cowling duct) in the cowling 40 reduce air pressure at high air-flow speeds to protect the filter assembly 15 and maintain the overall efficiency of the DAC device 10. The cowling 40 and vehicle grill (see front grill 99a of FIG. 3) can be modified with baffles and built-in drains for wet or snowy locations. An exemplary DAC device 10 is positioned between the radiator assembly 95 and front grill 99a. Vacuum flow arrow 105 indicates the movement of air into and through the system 1.

This DAC device 10 operates by directing airflow through the three air filters of the filter assembly 15, each filter positioned one after the other in a framed metal box, or housing 12, along with the particle container 35, which lies between the secondary filter 15b and tertiary filter 15c. The three particle filters are in the form of cartridges that slide via lengthwise grooves 16 cast into each filter's frame, the frame also holding air pressure and air suction devices, the housing interior capable of receiving the grooves 16. Being in cartridge form, the particle filters are tunable to conditions under which the vehicle 99 commonly operates, thus maximizing capture efficiency. The air pressure and vacuum system operates from its own sliding groove 16, in which the particle filters fit. The present system 1 can be tuned to remove viruses, smoke, plastic particles, road tire particles and other toxins from a particular area as desired by a user. The user can also be notified by sensors or AI about various pathogens including Ebola, Covid, Bird flu and others, as well as chemical materials including fentanyl, meth, radioactive particles, and others.

Particle filters can be quickly slid in and out, exchanging different filters such that particle size capture can be tuned to the range of particle sizes desired for a given area or application. The primary particle filter 15a is composed of woven metal mesh, captures road debris (gravel and sand), and discards the debris to the street below. The naturally occurring vibration affects the chassis of the filter assembly 15 or housing 12 to shake stubborn debris loose from the filter, the loosened debris falling down to the street below. A thin flexible suction wing runs along the leading edge of the primary particle filter 15a, at the exhaust region. It creates a further suction effect on the falling particles. The remaining air penetrates the primary particle filter 15a and enters a thin 1 to 2-inch empty area to meet the secondary particle filter 15b. This secondary filter 15b is composed of a membrane filter material such as a woven geotextile fabric or polypropylene geotextile, or alternately, HVAC quality spun poly, cloth, HEPA, ceramic honeycomb, graphene, or mechanical/electronic, cleanable, quick-change particle air filters.

Differences between surface and depth filtration can play a crucial role in DAC systems. With conventional filter fabrics, such as standard needle felts, the spaces between the fibers within the structure of the media are often considerably larger than the particles to be collected. The dust particles penetrate the surface of the media and close off the open pores, forming a filter cake on the surface of the media, promoting a phenomenon known as depth filtration. Without a filter cake on the surface, conventional filter media are rarely able to collect fine particulates efficiently. Over time, media blinding and atmospheric emissions occur as individual dust particles penetrate into and beyond the filter media. However, ePTFE laminated filters use the surface filtration methodology. The ePTFE surface acts as the contact area, and because of its microporous structure with millions of pores per cm², even sub-micron particles are captured on its surface. A backing substrate serves merely as a support and plays no part in the filtration process. There is no reliance on the build-up of a dust cake, and as such, the filter can be cleaned down far more effectively, maintaining a very stable differential pressure. Therefore, surface filtration can prolong the service life of the filter and provide significant cost savings in terms of reduced compressed air usage and pressure, as well as fan power requirements.

The secondary particle filter 15b captures particles down to PM10 and wipes them from the filter with the assistance of high-pressure air (directed from the top of the filter), a movable array of pulsing high-pressure air jets (on the other side of the filter), and/or sound blasts. Motion arrow 106 indicates the high-pressure downward air example. These loose particles are then directed down to the bottom of the secondary particle filter 15b where they are discarded to the street below. A thin, flexible suction wing runs along the leading edge of the particle filter exhaust, creating a further suction effect on the falling particles. Alternatively, the falling particles are directed to a trough with added vacuum that leads to a particle container 35 where they are saved to be discarded when full. The air then flows through tertiary particle filter 15c. This filter is composed of a membrane filter material (e.g. woven geotextile) or alternatively a HVAC quality spun polyester, cloth, HEPA, ceramic honeycomb, graphene, or mechanical/electronic, cleanable, quick-change particle air filters. Tertiary particle filter 15c captures particles down to PM2.5, which includes black carbon, pandemic particles, microplastics and tire wear particles as well as others. These particles are captured from the tertiary filter 15c with the assistance of high-pressure air directed from the top of the filter. The tertiary filter 15c comprises lengthwise tracks 25 via which the side-mounted vacuum component 20 can be slid and mounted.

Alternatively, as seen in FIG. 2, a sliding tube structure 26 comprising a manifold of vertical air tubes 27 connected to a lower horizontal air tube 28 slides back and forth such that each vertical tube 27a slides back and forth over its approximately 5-inch section of the filter assembly 15. Motion arrows 102 indicate the lateral movement of the manifold 27. Each vertical tube 27a has a slit 27aa cut vertically in the side facing the filter so that an internally applied vacuum pulls the captured carbon particle as well as other particles away from the filter and into the tube 27a. Alternatively, a built-in brush can be added to each of the vertical tubes 27a for the purpose of scrubbing the proximate filter. An optional high-pressure grid of air jets can apply pressure from the opposing side. Low frequency sound blasts can also be applied to achieve a similar particle-loosening result, along with direct vibration of the particle filters using a transducer. The captured particles are then drawn down a tube into the particle container 35 which stores the particles. These loose particles are then directed down to the bottom of the filter assembly 15 where they are directed to a trough with added vacuum that leads to a container where they are saved to be pumped out to an underground or above-ground tank at a gas station while the vehicle 99 is being refueled. UA and ozonation can be added before the particles reach the particle container 35 or after pump-out to sanitize if necessary. In one example, a sensor mast (in the area between the secondary particle filter 15b and tertiary particle filter 15c) measures air velocity, temperature, and pollution levels. The remaining airflow, now cleaned of particle materials, flows through the vehicle radiator assembly 95 and into the engine compartment.

The surface area of the intake region of the portable DAC device 15 in vehicles 99 is a key performance enhancer to the present system. To double or even triple the capturing surface area, and therefore an equivalent amount of carbon captured by the vehicle 99, the DAC device 15 can be placed in several other areas of a vehicle 99. Doors are a natural site since they are essentially empty and have a considerable amount of airflow alongside them. In one example, the present DAC device 15 fits within the car doors, with each door having a large scoop designed into it (e.g. Ferrari/McLaren). The captured particles from each DAC device 15 are vented via a flexible tube running through each door's hinge area to a central storage compartment below, along with the front device 15 and any other carbon capture modules to be pumped out at refueling. During refueling, the vehicle's carbon based fuels are pumped into the vehicle's fuel tanks while captured carbon particles are pumped out using a one-piece dual outlet plug refueling system. A rear scoop with another built-in DAC device 15 could be added to this system 1. Both doors, rear scoop, and front module would have a far more substantial combined surface area. This concept could be adapted to delivery vans/trucks too.

In another example, for sites that require a longer, flatter design that can be applied to the sides and roofs of cars and trucks, the unit can be modified. The three vertical particle filters placed one after another can be placed at a radical angle relative to air flow, such that microparticles (that are repelled by each of the filters) are pushed down the filter by the above-mentioned strong airflow and end up at the bottom of the filter where suction is applied to remove and transport them to a pipe leading to one or more particle containers 35. This alternate configuration can be used to install the portable DAC device 10 at fixed sites, including the walls of high-rise buildings, homes, and the roofs of warehouses. A fixed DAC device can utilize stationary panels and energy efficient fans powered by solar panels, with various applications such as with windows, vents, exterior wall units and billboards. The present system 1 can turn the rooftops of warehouses, office buildings, and homes into carbon capture systems.

The present DAC system 1 can operate under its own control, power, and sensors. In another example, the system 1 can operate as a component of a large network platform of units. In other examples, the present DAC system 1 can be placed under manual control on the dashboard, having network control executed by other nearby devices, AI control via WiFi, or sensor control.

Carbon collection is an important part of the total DAC system 1. Current DACs are in many cases near oil fields and use pipelines to move the captured CO₂ to wells for injection. The present invention is built around a conventional gas station format to reduce costs, while making it easier for a consumer to use. When the consumer drives in to fill up on gas, the present DAC system 1 can utilize a fuel hose that includes a vacuum out-hose and a fuel in-hose, an all-in-one device. A below ground tank is used to store the carbon to be picked up by truck, or in some cases connected to carbon transport pipelines, which are quite common in the Midwest. Numerous efforts are currently being made to find more uses for captured carbon. However, carbon particles reaching a long-term storage area are not pressurized like CO₂. Once injected into old wells or other geological voids, carbon particles are expected to solidify into stable formations. Alternatively, there is a move toward E-fuels, which will require that carbon capture play a crucial role.

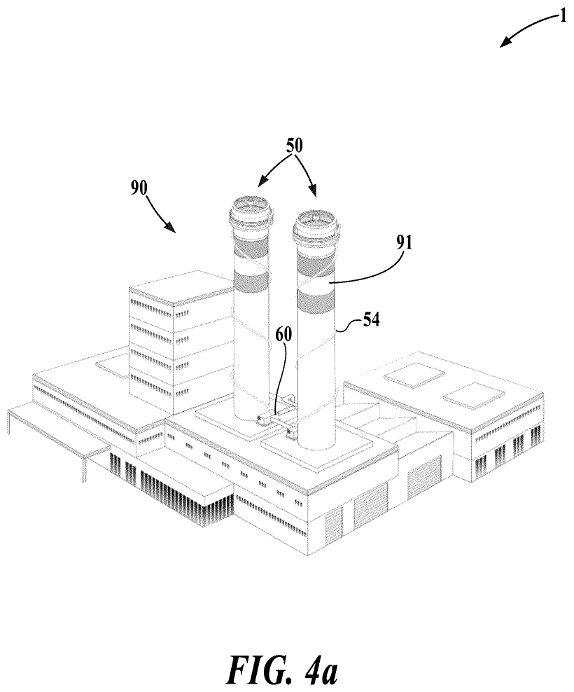

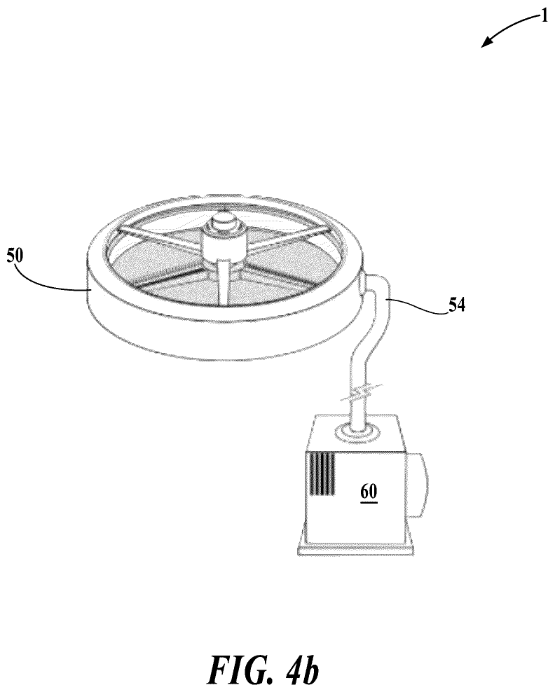

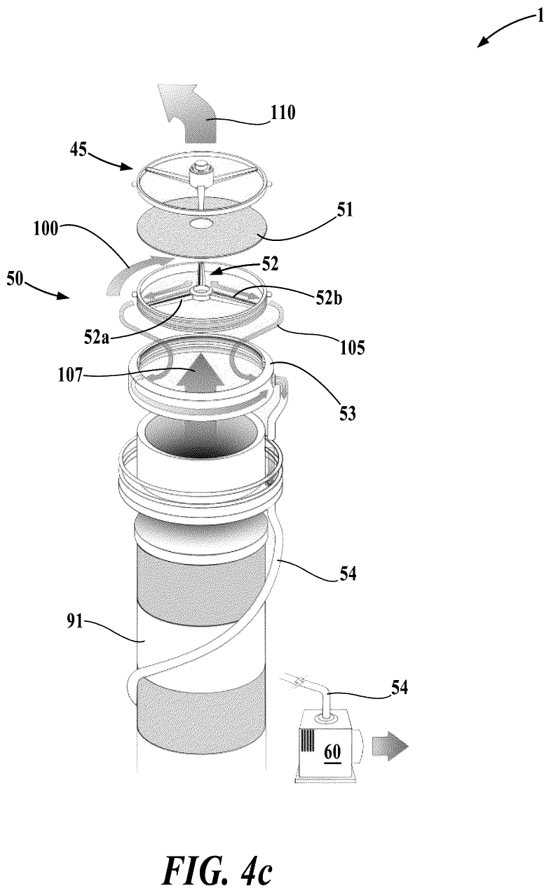

Referring to FIG. 4 (4a, 4b, and 4c), an alternate embodiment of a DAC device 50 is designed for power plants 90. In this example, an exemplary DAC device is shaped in the form of a disk that fits on top of a power plant smokestack 91 and is composed of a porous ceramic filter disk 51, such a DAC system 1 comprising a suction wiper 52, and a tube 54 connected to a container at the bottom of the smokestack 91. Hot exhaust gases flow up a smokestack 91 at approximately 35 mpg, as indicated by smokestack emission arrow 107. They first flow through the docking and vacuum collar 53 which is installed at the top of the smokestack 91. These gases contain up to 30% carbon by volume. Vacuum arms 52 with suctioning means, or troughs 52a, and debris filter brushes 52b slowly rotate over a ceramic foam filter 51 and clean the carbon particles captured by the filter, as indicated by rotational brush arrow 100. The carbon particles are sucked into the vacuum arms 52 via the troughs 52a, drawing vacuum pressure from the docking collar 53. The captured carbon is then transferred via a flexible tube-cables, or suction/power cables 54, which include an electric power cable and sensor and control cables down the side of the smokestack 91 to a water separator 60, removing moisture from the DAC system 1. Vacuum flow arrows 105 indicate the movement of air from vacuum arms 52 to cables 54. Carbon particles are then drawn into storage tanks at ground level, subsequently being transported to a pipeline or tanker for disposal or reuse. Motion arrow 110 indicates the movement of clean exhaust air out and away from the system 1.

The connective suction/power cables 54 running between the DAC device 50 at the top of the smokestack 91 and the ground combines two tubes to carry the captured carbon microparticles from the DAC device 50 to the ground combined with electrical power and sensor/control cables all consolidated into a cable that wraps/spirals down the smokestack 91. This eliminates attachments within the concrete while providing a streamlined and unobtrusive aesthetic. The suction/power cables 54 are flexible, having a top end that plugs into an initial base plate that inserts into the top of the smokestack 91. Installation is quick and cost-effective. When the DAC device 50 arrives overhead, carried by a large industrial drone via a cable attached to a built-in ring in the center/top of the device 50, the unit is set down and fits into the base plate. It settles in and snaps thus connected firmly to the base plate. The connective tube-cable 54 is attached to the base plate. When the DAC device 50 is dropped into place, it self-aligns with exhaust ports for the waste carbon stream, as well as the connective power and control/sensor cable 54. This allows the whole unit to be removed on a calm day, quickly brought down, inspected, the ceramic filter 51 changed if necessary, and flown back up. There is no need for an expensive technical team. The DAC device 50 as discussed is stationary, but the vacuum arms 52 spin at varying speeds applying suction to continuously clean the ceramic filter 51 of captured carbon. The ceramic foam filter 51 is capable of performing under substantial heat. The three-legged configuration to support the vacuum wiper arms 52 can alternatively be replaced by using the ceramic filter 51 itself. A drive shaft that spins the wiper arms 52 runs through the ceramic filter 51 to a streamlined/insulated electric motor 45 on the top of the DAC device 50. A lifting ring is attached to it. The DAC device 50 is designed to be as light as possible. The device 50 has a failsafe mechanism that allows it to pivot open if air flow resistance rises too high (meaning the filter 51 is full) or if it is remotely operated to open.

In summary, the invention is configured to operate in all manner of vehicles 99 as well as regions of the world. However, the present DAC device 15 operates at its maximum efficiency in large vehicles, such as trucks, delivery vans, SUVs, and pickup trucks that have large engines 96 and radiators 95, as well as large body surfaces. Moreover, the present invention operates better in polluted, high carbon areas, including urban city areas, industrial areas and construction areas. It further operates better in high mileage vehicles 99 like long distance trucks and buses. The DAC system 1 continuously filters the air of carbon, viruses, and plastic microparticles in underground and above-ground parking lots having a static or moving platform vehicle, air flow capture enclosure, self-cleaning filters, particle container fan, communications, and sensors.

Referring to FIG. 5 (5a and 5b), side and front views of a rotating carbon capture (DAC) device 75 are illustrated. In this embodiment of the DAC system 1, the DAC device 75 comprises a strut assembly 80, debris filter brushes 82, air injectors 83, carbon capture/debris ducts 84, and electric motor assembly 45 with motor drive 45a, drive gear 45b, and drive shaft 45c. The radiator 95 with cooling fan 95a is positioned at the front of the device 75. The strut assembly 80 is a layered structure comprising a first strut 80a, second strut 80b, and third strut 80c, these struts fixed relative to an axle 81 running through the strut assembly 80. Proximate to the third strut 80c lie the air injectors 83. The debris filter brushes 82 lie in a sandwiched pair between and linearly aligned with the struts of the strut assembly 80, one brush lying between the first strut 80a and second strut 80b, the other brush lying between the second strut 80b and third strut 80c. Beneath the strut assembly 80 lie a pair of carbon capture debris ducts 84, one duct opening on a top intake end between the first strut 80a and second strut 80b, the other duct opening on a top intake end between the second strut 80b and third strut 80c, the former duct having an exit opening leading to the exterior of the DAC device 75, the latter duct having an exit opening leading into the particle container 35. Vacuum flow arrows 105 indicate the movement of air, or cowling venting, through the debris ducts 84. Referring to the front view of FIG. 5b, a particle container intake 84a is illustrated. Motion arrows 101 indicate the rotation of particle filters 76.

The DAC system 1 automatically captures carbon, viruses, and plastic microparticles, without consuming energy or emitting carbon emissions, and is powered by aerodynamic shapes that capture and focus air-flow. In one example, the DAC system 1 utilizes parasitic energy from the moving platform to which it is attached. In another example, the DAC system 1 is integrated into renewable energy devices. The system 1 can be combined with one of several established or developing carbon capture systems that separate the micro-particles from the airflow input, thus improving overall efficiency while also capturing black carbon and other particles for later reuse. Additionally, the system 1 can easily be retrofitted to older vehicles. Multiple embodiments of the present system 1 can include universal coupling, an air-flow capture enclosure, self-filtering filters, particle containers, computers, fans, software and sensors.

The system 1 allows for disposal of captured carbon, viruses, and plastic microparticles. Some embodiments utilize a static or moving platform vehicle, air-flow capture enclosure, self-cleaning filters, particle container output port, an external pump-out station, and/or a captured particle storage container. The DAC system 1 improves the storage of captured carbon by providing access to suitable storage sites and keeping it there. It improves the global environment by reducing air, water, and ground content that includes carbon, viruses, and plastic microparticles. The system 1 can operate as a mobile global atmospheric filtering system aimed primarily at black carbon and pandemic particle airflow. The system 1 can include a mobile DAC device that can be used in cars, trucks, and other vehicles as a mobile platform, while not requiring such vehicles to be modified to cost, minimizing the time it takes to change production, preventing the need for extra service. In one example, a DAC device can be installed in a truck that utilizes compressed air (used for brakes and air suspension on trucks) via the DAC device's air nozzles. A portable DAC device 10 can be used for windows and vents in buildings, and can be attached as thin panels to walls, buildings, and roofs powered by solar power, or other natural energy source. Additionally, a unit that is not mounted in a vehicle can utilize a fan to operate on rooftops, winds, and billboards.

DAC devices associated with the present system 1 enhance filter efficiency by utilizing several filter shapes, including flat, funnel, bulbous semi-spherical, and radiator shapes. The DAC devices direct polluted air-flow to travel through a filter medium at an oblique angle, thus improving the flow of rejected microparticles along the filter barrier and into a tube at the center of the funnel filter leading to the particle container 35. The DAC devices filter atmospheric air-flow by pushing the air through a smooth non-stick filter at an oblique angle so that the micro-particles that are repelled by the filter are pushed away by a windshield wiper type arm comprising high-pressure nozzles, a non-abrasive brush, and ultrasonic vibration to help the particles break free of the filter. The DAC device includes a device to control the speed of filter rotation, nozzle air pressure, and ultrasonic frequencies applied to filter brushes.

A DAC device can be highly miniaturized with a small footprint, so that it can be placed inside or very close to the position of the carbon emissions. Thus, it is highly adaptable to varying polluted areas. DAC devices can filter out black carbon microparticles, which remain airborne for weeks at most compared to carbon dioxide, which remains in the atmosphere for more than a century. DAC devices are designed to be built locally using locally sourced materials, thus providing high quality jobs for many thousands of workers across the planet. Moreover, the present DAC system 1 turns every major company headquarters into a carbon capture site by having the large parking lots full of employee vehicles equipped with the system 1, which gives the corporate fleet the ability to clean the local air of carbon and microplastics.

A DAC device captures carbon, pandemic, and plastic microparticles from the atmosphere. It is designed to capture solid microparticles of carbon, but not CO₂ because that is a gas which, once released, immediately disperses into the surrounding atmosphere, becoming less than 1% of the total mixture and requiring complex equipment and energy to capture. The present DAC system 1 can suppress carbon in the atmosphere if it operates on a large-scale basis around the world. It removes CO₂ from ambient air utilizing a digital analysis system to monitor and correct global pollution, and includes a moving platform, air-flow capture enclosure, sensors, a fan, self-cleaning filters, and a CO₂ permeable filter and particle container. DAC devices capture PFAS particles and other toxic particles in the atmosphere, including many of the 187 particles the EPA has designated in the air as toxic.

The present DAC system 1 can be applied to an automobile having a moving platform, air-flow capture enclosure, self-cleaning filters, and particle container, with the filtration intake built into the grill feeding the decarbonation mechanism further back and exhausting the filtered air from the rear of the vehicle. A mobile platform that supports a DAC device can be remotely operated to drive back-and-forth to hunt down continuously changing high density polluted air sites. A DAC device can be self-contained and sized to fit on the back of a small pickup truck. The DAC device can be embedded in a moving vehicle to capture millions of black carbon microparticles, pandemic-related organisms, and other air-flow passing around and through the vehicle, transporting them to a container to safely store them for later removal. The device can be integrated into mass-produced vehicles utilizing standard service/maintenance facilities to check and repair mechanical and electrical components. DAC devices can be embedded in vehicles that include an automatic disposal of captured carbon microparticles. The devices can be embedded in vehicles that filter the air of microparticles even when the vehicle is parked inside a public or private house or parking lot. DAC devices can be used to clean the air of large parking lots full of vehicles, when those vehicles are equipped with the DAC system 1. DAC devices can be integrated into mass-produced vehicles that utilize standard service/maintenance facilities to check and repair mechanical and electrical components. A self-cleaning filter can be positioned inside a mobile platform (vehicles, ship, trains) experiencing movement that powers the air-flow through the DAC device.

The system 1 can use autonomous vehicles and swarm intelligence, the collective intelligent behavior of decentralized systems, to build collaboration among vehicles and to speed up the filter control of highly polluted areas in times of emergencies, such as fires and toxic industrial leakages. DAC devices can be attached to a subway car or towed behind to protect subway commuters who are exposed to dangerous levels of pollution. Levels of automation for autonomous vehicles may vary between vehicles, including either human-assisted partial automation or full automation, depending on the mission. Some embodiments include a very large network platform that autonomously maintains global climate stability, this platform including a large number of moving vehicles, air-flow capture enclosures, self-filtering filters, particle containers, computers, fans, software, and sensors. Such an embodiment of the DAC system 1 can connect to the electrical power and computer of the host vehicle to send and receive data. DAC devices can further be automatically programmed to cover certain areas of a city during their high traffic pollution hours.

In some examples, an AI (artificial intelligence) enabled global ecological support network platform includes many devices that are enhanced with sensors, AI, and analytical capabilities such that the system 1 makes data-based decisions and automatically completes key tasks concerning maintaining global carbon based air quality stability. This allows for improved carbon and pollution forecasting. It further helps guide future DAC investments toward a lower footprint venture, with the aim of superior sustainable development goals. AI has the potential to accelerate global efforts to protect the environment and conserve resources by detecting energy emissions reductions, thus improving CO₂ removal and helping to develop greener transportation networks. It further helps to forecast dense pollution as well as limited visibility for urban traffic. Combining AI with the present invention creates an air purifier and bio-purifier on a global scale. Further, using machine-learning based tools that analyze local air quality data can boost accountability and credibility of carbon offsets. Companies can use the DAC/AI platform to measure, reduce, offset, and report their greenhouse gas emissions. States can use a “regional filter” concept tuned to the major type of pollution in their area. The present DAC system 1 can form a part of a global ecological support network platform that is used to stabilize and protect nature and worldwide weather by stabilizing carbon particle densities in the global atmosphere. Such a system 1 acts as an AI-enabled global support network platform composed of millions of sensors, DAO air/water/land engines, and oxygen regenerators operating as a global thermostat to maintain a sustainable planet climate through controlling and regulating the climate. The DAC system 1 can address accelerating global warming by being designed to be implemented on a global scale and make maximum impact far quicker than other DAC schemes.

The present DAC system 1 is highly adaptable to numerous alternative static versions such as a AQI version attached to high rise buildings which utilizes aerodynamic forces to pull air through a particle filter and then through the microparticle filter to separate air-flow and direct them to a containment area. Additionally, the system 1 can incorporate an internal electric fan allowing the mechanical device to operate in large open air parking areas making it a massive AQI filtering system powered by a standard electric vehicle power system. Such a system can operate as a platform network as each mobile unit includes wind, AQI sensors, and is connected to the platform by WiFi/5G sending real-time data to AI-driven decision-making to improve the capture efficiency of the entire network of mobile and static systems. The DAC system 1 can include an autonomous climate control network platform that supports climate stability, as well as a global network platform with millions of sites that can be used for security, information, and advertising.

In one example, the present DAC system 1 can implement devices that capture black carbon emissions from ships at sea and port caused by burning heavy fuels. In another example, an airborne DAC system 1 can capture and store toxic emissions from forest and industrial fires. DAC devices can be used to suppress emergency toxic events and refinery output. DAC devices can be mounted to robotic cranes while implementing AI and machine vision technology in order to filter polluted air emitted from large construction sites. The DAC system 1 can promote the suppression and control of military bio-war, weaponized gases, and radioactive materials by utilizing autonomous military vehicles that can collect real-time intelligence and support decision-making to help collect and neutralize such threats on the battlefield or during an urban terrorist event. The DAC system 1 can suppress and manage small, localized pandemic outbreaks before they can spread widely. It can be used as a permanent global defense system against future pandemics by cost-effectively filtering out harmful microparticles on a global level.

The present system 1 can implement an atmospheric air quality mechanism that can be either static or mobile. Such a mechanism can be in the form of self-perpetuating commercial models, allowing the present system 1 to be profitable, and creating a huge, investable financial opportunity that is scalable worldwide. Such a financial model is necessary to neutralize the global air quality problem. Moreover, the present DAC system 1 achieves a lower cost than conventional large-scale carbon capture systems with a high cost of operation (energy) and build costs (materials). The system 1 can pay its cost off entirely through a leased series of inventions for large rooftop versions using carbon credits. Automatic carbon credits can be credited to a credit card for each captured carbon dump to an automobile service station. The present system 1 can pay its cost off entirely through a leased series of inventions for large rooftop versions using carbon credits. Automatic carbon credits can be credited to a credit card for each captured carbon dump to an automobile service station. Automatic carbon credits can be credited to a credit card for each captured carbon dump to an automobile service station.

The DAC system 1, can be embedded in a moving vehicle to capture millions of black carbon microparticles, pandemic-related organisms, and other air-flow passing around and through the vehicle, transporting them to a container to safely store them for later removal. The system 1 operates by directing airflow through three air filters, the primary filter 15a separates out debris (gravel and pebbles) and discards it to the street below. The secondary filter 15b discards anything over PM10 including particles composed of dirt, dust, and sand and discards them to the street below. Alternatively it can save them to a particle container which can be offloaded when full. The tertiary filter 15c captures the smaller size black carbon, pandemic, road wear and micro-plastic particles remaining in the air-flow. These are caught and held by filter three then continuously removed by a slow-moving automatic air nozzle blast combined with a brush activated by ultrasonics. The loose particles are then swept by the air-flow into an integrated container for later removal.

A DAC device of the present system 1 does not emit any noise during operation, nor has any emissions, and is safe from explosion or fire. It uses little to no energy during normal operations, which use the motion of the vehicle platform to power its operation. It can also operate using its low energy electric fan when an internal CO₂ sensor signals unusually high emissions, and can also operate in a parked electric vehicle when hooked up to an electric car recharging station. The system 1 can be produced with a simple, low cost, low labor automotive-type pop-together manufacturing system allowing the number of DAC units to reach into the billions, thus allowing them to be built in any country with minimum investment, creating quality jobs for developing countries. An associated DAC device production system and materials used for service and maintenance are all designed to reduce energy consumption, cost, and waste.

The DAC devices are small enough to operate in all vehicles, cheap enough to be scaled in billions, simple enough to be manufactured almost anywhere. They are designed for low impact, build anywhere, manufacturing, and does not require rare earth metals, large amounts of water, or energy. Moreover, they do not require the redesign of an automobile in any way. A DAC device can be a one-piece mechanism that is simply bolted on and fits all vehicles during the manufacturing process, or as an add-on component. Furthermore, it can be connected to an airflow sensor, which is in every car. In some examples, it can include a platform carrying each unit and functioning as an IoT (Internet of things) device. Additionally, such a DAC device can act as a hybrid, combining IoT, meta, AI, and other cutting edge technologies to solve the planet's biggest problems, including global warming, depleted groundwater, and pandemics.

DAC devices are designed to be highly adaptable to many locations and applications including elevators, tow motors, trams, coal mining movers, oil drilling operations, motorcycles (downsized version), helicopters, lawnmowers, generators large and small, airport runway cleaners, and construction sites. It is also designed to safely and permanently sequester captured carbon underground. The present DAC system 1 highly adaptable to many operations and configurations, including placement on a trailer and towing to high emissions areas when they occur (e.g. forest and factory fires), toxic emissions events (chemical and petrochemical sites), as an autonomous thing (AuT) that will automatically hunt and gather air-flow, ultra-cheap versions that can be built for developing world urban areas, small systems designed for ultra-dense housing areas to capture pandemic air-flow, a wet filter version for higher efficiency, and a system that bolts on to the front of a vehicle's radiator.

The operating lifetime of the system 1 is maximized by being composed of a minimal number of parts and moving parts, which means there is need for a minimal number of parts inventory for repair and replacement. Moreover, all moving parts are well protected from heat and moisture as well as being inside an enclosure and a vehicle. The system 1 is designed to have its hardware and software cost-effectively upgradable. A DAC filter medium life expectancy is 5-7,000 miles—similar to the period between oil changes. The DAC system 1 is designed to act as a “forever system”. As population increases, increasing technology-driven activities, high intensity carbon emission events like massive forest fires, increasing volcanic activity, and even wars will challenge the global atmospheric balance. The present DAC system 1 can operate for decades, even centuries, in order to rebalance the atmosphere and maintain a proper ecological balance.

The present DAC system 1 has numerous advantages relative to conventional DAC systems, including the following: lower costs and energy consumption for building, installing, operation, and recycling, eliminating safety issues, minimal water consumption, unlimited operational surface area, ease and speed of scaling, environmental market demand, accessibility to the densest areas of carbon (resulting in profitability), ability to separate out particles of varying size such as carbon from microplastics, eliminating the need for renewable energy power sources like other DACs (which require them to compensate for their high-energy consumption), being an asset to the developing world (which is a major source of carbon emission), eliminating the need for the world's electricity grid to be modified and substantial pipeline added to deal with captured carbon, and eliminating the need for adding about 50 million miles of electricity grid to sustain the energy transition, a viable low-cost carbon source for the production of e-fuels.

Embodiments of the present invention are AI-enabled. This creates better carbon and pollution forecasting. It helps guide future DAC investments toward lower footprint ventures with the aim of superior sustainable development goals. AI has the potential to accelerate global efforts to protect the environment and conserve resources by detecting energy emissions reductions, thus improving CO₂ removal and helping to develop greener transportation networks. It helps forecast dense pollution as well as limited visibility for urban traffic. It operates as an air purifier and bio-purifier on a global scale. Further, using its machine-learning based tools that analyze local air quality data boosts the accountability and credibility of carbon offsets. Companies can use the platform to measure, reduce, offset and report their greenhouse gas emissions.

The present invention, a combination of AI, a network platform, and a fleet of DAC carbon capture vehicles provides a ready defense against AQ toxic incidents, including corporate, car, truck, and natural fires. The moment one of these toxic incidents begins, AI will analyze it, and using real-time weather data, project its most probable route. It will then follow its moving location, activating any and all DAC-equipped vehicles that are parked or traveling through the toxic zone. Police cars, daily delivery trucks, and other all day working vehicles could have several DAC units attached to them, which would triple or more their absorption capacities.

Energy sources for DAC need to be zero or very low carbon to maximize new capture efficiency. One of the leading DAC companies, Climeworks, estimates a long-term energy requirement of 2,000 kWh/tCO2 for their solid absorbent system. Another leading DAC company, Carbon Engineering, estimates energy requirements of 2,400 kWh/tCO2. For solvent-based DAC systems (carbon engineering), capturing one ton of CO₂ can require 1-7 tons of water. Solid sorbent systems vary widely in terms of water usage. The ones that use steam use approximately 1.6 tons of water per ton of CO₂ captured. An IC car/truck equipped with the present invention could claim lower emissions overall if captured emissions are deducted from tailpipe emissions.

Every major company in the world can now use its own employees to fight climate change. There are 2.1M employees for WalMart, 1.5M employees for Amazon, 530 k for FedEx. There are 19.2M federal employees, 3.2M state employees, and 1.4M military employees. There are a total of 170M workers employed in the US and 200M employed in the EU. They all could have their cars equipped with the present DAC system to capture carbon while driving to and from work and while parked at work. There are 30,000 companies in the US, each with over 1,000 employees.

The present invention is designed to minimize parts count and complexity. The system needs no more space, water, or power resources. It utilizes the thousands of established auto parts manufacturing plants and 40 million miles of roads in the world with no need for high-pressure pipelines for transmission of captured carbon, and only some of the 2-3 million abandoned oil/gas wells worldwide. Many of the platforms used by the invention are vehicles, and therefore are carbon copy versions of commercial vehicles. Other parts are consumer, electronic and other replaceable goods. Their per unit cost is relatively low, and they can be bought in large volumes from many companies, with new and better versions becoming available more often. These criteria for any new DAC related capabilities would apply to the invention in all sizes and in all domains, such as applications of data management and analysis, artificial intelligence, networking, autonomy, cybersecurity, software applications and other digital capabilities. It can further adapt to other alternative industrial bases. The present invention empowers carbon capture consumers to start buying what they think they need now, within the defined market for these alternative capabilities. Thus, better versions of the system's capabilities would quickly emerge at greater scales that can meet the many new and different needs that may arise at operational sites. This would build stakeholders in the future, while helping to find profit in the new systems.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

There may be many other ways to implement the disclosed embodiments. Various functions and elements described herein may be partitioned differently from those shown without departing from the scope of the disclosed embodiments. Various modifications to these implementations may be readily apparent to those skilled in the art, and generic principles defined herein may be applied to other implementations. Thus, many changes and modifications may be made to the disclosed embodiments, by one having ordinary skill in the art, without departing from the scope of the disclosed embodiments. For instance, different numbers of a given element or module may be employed, a different type or types of a given element or module may be employed, a given element or module may be added, or a given element or module may be omitted.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. A direct air capture system for a vehicle, the system comprising:
(a.) a radiator assembly having a front end and a back end, the radiator assembly comprising a cooling fan;
(b.) an air filtration device is attached to the radiator assembly's front end and configured to capture, contain, and transport airborne matter including CO₂, particulate matter including radioactive and chemical matter, and pathogens, the air filtration device comprising:
(i.) a filter assembly having a primary, secondary, and tertiary particle filter, each filter being a cartridge with lengthwise grooves, the primary particle filter having a woven metal mesh composition for capturing road debris, the secondary particle filter having a membrane material composition with PM10 rating, the tertiary particle filter having a membrane material composition with PM2.5 rating and comprising lengthwise tracks;
(ii.) a particle container configured to receive airborne matter loosened from the filter assembly, the particle container positioned between the secondary and tertiary particle filters;
(iii.) a housing for the filter assembly and particle container, the housing configured to receive the cartridge grooves;
(iv.) cowling piping configured to pressurize and vent airflow, and increase surface area of particle capture, the direct air capture system directing airborne matter toward the cowling piping; and,
(v.) a vacuum mounted to the tertiary filter via the lengthwise tracks, leading to the particle container, and configured to pull airborne matter away from the tertiary particle filter and toward the particle container. wherein the air filtration device is further configured to be positioned between the radiator assembly and the front grill of a vehicle.

2. The system of claim 1, wherein a fluorocarbon polymer coating is added to the housing, cowling piping, and particle container to improve particle flow.

3. The system of claim 2, wherein the cowling piping comprises air ducts configured to reduce air pressure at high air-flow speeds.

4. The system of claim 3, wherein the air filtration device further comprises a sliding tube structure having a manifold of vertical air tubes connected to a lower horizontal air tube, the tube structure sliding back and forth such that each vertical tube slides over its approximately 5-inch section of the filter assembly.

5. The system of claim 4, wherein each vertical air tube has a vertical slit facing the filter assembly, and wherein an internally applied vacuum pulls airborne matter away from the filter assembly and into the vertical tubes through the slits.

6. The system of claim 5, wherein each vertical air tube comprises a scrubbing brush configured to loosen airborne matter from the filter assembly.

7. The system of claim 6, wherein the air filtration device further comprises a grid of high-pressure air jets configured to apply pressure to the particle filters in order to loosen airborne matter from them.

8. The system of claim 7, wherein the air filtration device further comprises a means for applying low frequency sound blasts to the particle filters in order to loosen airborne matter from them.

9. The system of claim 8, wherein the air filtration device further comprises a sensor mast positioned between the secondary particle filter and tertiary particle filter, the sensor mast configured to measure air velocity, temperature, and pollution levels of airborne matter.

10. A direct air capture system for capturing, containing, and transporting airborne matter, the system comprising:
(a.) a filter assembly;
(b.) a particle container configured to receive airborne matter loosened from the filter assembly;
(c.) a means for cowling venting configured to utilize vacuum pressure to transport the airborne matter;
(d.) an electric motor assembly comprising a motor drive, a drive gear, and a drive shaft; and,
(e.) at least one scrubbing brush configured to loosen airborne matter from the filter assembly.

11. The system of claim 10, wherein a fluorocarbon polymer coating is added to the cowling venting means and particle container to improve particle flow.

12. The system of claim 11, wherein the cowling venting means comprises air ducts configured to reduce air pressure at high air-flow speeds.

13. The system of claim 12 comprising sensors configured to measure air velocity, temperature, and pollution levels of the airborne matter.

14. The system of claim 13, wherein the airborne matter includes CO₂, particulate matter including radioactive and chemical matter, and pathogens.

15. The system of claim 14, wherein the filter assembly comprises at least one particle filter having one of several filter shapes, including flat, funnel, bulbous semi-spherical, and radiator shapes.

16. The system of claim 15 comprising an AI (artificial intelligence) enabled global ecological support network platform having sensor-enhanced devices and configured with analytical capabilities to make data-based decisions and automatically maintain global carbon-based air quality stability in order to improve carbon and pollution forecasting.

17. The system of claim 16, wherein the capturing, containing, and transporting of airborne matter does not emit any noise or emissions during operation of the system.

18. The system of claim 17 comprising high-pressure air jets configured to apply pressure to the at least one particle filter in order to loosen the airborne matter from them.

19. The system of claim 18, wherein at least one of the particle filters and scrubbing brushes rotates during operation of the system.

20. The system of claim 19, wherein automatic carbon credits can be credited to a credit card for each captured carbon dump to a service station.
